(19) United States
(12) Patent Application Publication
(10) Pub. No.: US 2025/0348616 A1
(43) Pub. Date: Nov. 13, 2025

(54) SYSTEM AND METHOD FOR CONSTRUCTING BLOCKCHAIN LEDGER OF SHARED DIGITAL CONFIDENTIAL INFORMATION

(71) Applicant: The United States of America as represented by the Secretary of the Navy, San Diego, CA (US)

(72) Inventor: Brandon A. Durepo, Julian, CA (US)

(73) Assignee: The United States of America as represented by the Secretary of the Navy, San Diego, CA (US)

(21) Appl. No.: 18/662,767

(22) Filed: May 13, 2024

(51) Int. Cl. G06F 21/62; G06Q 20/40; H04L 9/00

(52) U.S. Cl. CPC G06F 21/6245; G06Q 20/401; H04L 9/50

(57) ABSTRACT

A system and method for constructing blockchain ledger of shared digital confidential information. The system comprising a blockchain ledger comprising a public access history of digital confidential information at a plurality of local ledgers; a database comprising the digital confidential information accessible by users having access credentials; a processor; and a non-transitory computer readable medium storing machine-readable instructions that when executed by the processor cause the processor to: initialize a transaction at a client node of the blockchain ledger, broadcast a transaction invocation request to a plurality of peer nodes, endorse the transaction at one or more peer nodes, submit the transaction to an order node, deploy a block comprising the transaction on a blockchain, wherein the transaction is properly ordered at the order node, broadcast the transaction to the plurality of peers, and update the plurality of local ledgers with the transaction block.

### STATEMENT REGARDING FEDERALLY-SPONSORED RESEARCH AND DEVELOPMENT

The United States Government has ownership rights in this invention. Licensing inquiries may be directed to Office of Research and Technical Applications Naval Information Warfare Center Pacific, Code 72120, San Diego, CA, 92152; telephone (619) 553-5118; email: NIWC_Pacific_T2@us.navy.mil, referencing Navy Case No. 211,364.

### FIELD OF USE

The present disclosure pertains generally to a blockchain-enabled chain-of-custody ledger of shared confidential information.

### BACKGROUND

Individuals and organizations spend extensive time and resources on the securing of confidential information. In the past, common security precautions would include safes and locking drawers, but the digital age has created a new need for cyber security method. Blockchain technology offers a unique advantage in this cybersecurity applications due to its immutable and distributed architecture. The blockchain consists of hash functions that can be used to generate digital fingerprints for secure transaction verification. These fingerprints, along with a public ledger, allow for chain-of-custody tracking for digital information. A chain-of-custody is a chronological record of an item's handing throughout its lifecycle designed to improve security and visibility. Implementations of chain-of-custody blockchains have manifested in a few instantiations, one being legal evidence. Logging legal evidence transactions on a blockchain provides a tamper-proof record of those handing the evidence preventing spoilage. However, this approach focuses on protecting evidentiary integrity instead of managing access. There is a need for further integration of distributed blockchain ledgers with data rights management to properly permit and track access. Furthermore, there is a need for metadata associated with each transaction in the chain-of custody to be monitored for proliferation.

### SUMMARY

According to illustrative embodiments, a blockchain ledger system for shared digital confidential information, comprising: a blockchain ledger comprising a public access history of digital confidential information at a plurality of local ledgers; a database comprising the digital confidential information accessible by users having access credentials; a processor; and a non-transitory computer readable medium storing machine-readable instructions that when executed by the processor cause the processor to initialize a transaction at a client node of the blockchain ledger, the transaction comprising access metadata and access credentials, broadcast a transaction invocation request to a plurality of peer nodes, endorse the transaction at one or more peer nodes, submit the transaction to an order node, deploy a block comprising the transaction on a blockchain, wherein the transaction is properly ordered at the order node, broadcast the transaction to the plurality of peers, and update the plurality of local ledgers with the transaction block including the metadata to the public access history.

In one embodiment, a method for tracking the proliferation of confidential data, the steps comprising: initializing a transaction at a client node of the blockchain ledger, the transaction comprising access metadata and access credentials, broadcasting a transaction invocation request to a plurality of peer nodes, endorsing the transaction at one or more peer nodes, submitting the transaction to an order node, deploying a block comprising the transaction on a blockchain, wherein the transaction is properly ordered at the order node, broadcasting the transaction to the plurality of peers, and updating the plurality of local ledgers with the transaction block including the metadata to the public access history.

It is an object to provide a System and Method for Constructing Blockchain Ledger of Shared Digital Confidential Information that offers numerous benefits, including chain-of-custody blockchain security and tracking of the proliferation of the original data.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The accompanying drawings, which are incorporated in and form a part of the specification, illustrate example embodiments and, together with the description, serve to explain the principles of the invention. Throughout the several views, like elements are referenced using like references. The elements in the figures are not drawn to scale and some dimensions are exaggerated for clarity. In the drawings:

FIG. 1 shows a block diagram illustration of a blockchain ledger system for shared digital confidential information.

FIG. 2 shows a block diagram illustration of a blockchain ledger system for shared digital confidential information comprising two organizations.

FIG. 3 shows a block diagram illustration of a method for tracking the proliferation of confidential data.

### DETAILED DESCRIPTION OF EMBODIMENTS

The disclosed system and method below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other systems and methods described herein as will be understood by one of ordinary skill in the art unless otherwise stated specifically.

References in the present disclosure to “one embodiment,” “an embodiment,” or any variation thereof, means that a particular element, feature, structure, or characteristic described in connection with the embodiments is included in at least one embodiment. The appearances of the phrases “in one embodiment,” “in some embodiments,” and “in other embodiments” in various places in the present disclosure are not necessarily all referring to the same embodiment or the same set of embodiments.

As used herein, the terms “comprises,” “comprising,” “includes,” “including,” “has,” “having,” or any variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, use of words such as “the,” “a,” or “an” are employed to describe elements and components of the embodiments herein; this is done merely for grammatical reasons and to conform to idiomatic English. This detailed description should be read to include one or at least one, and the singular also includes the plural unless it is clearly indicated otherwise.

Blockchain networks are distributed systems that enable a tamper-proof chain-of-custody tracking. Each block comprises one or more transactions that, together, form an immutable ledger. A blockchain object or “block” may be a hash of a record stored in the off-chain storage. In another example, the blockchain object may be a smart contract deployed on a blockchain. Because block header include a hash of the block's transactions and the of the previous block's header, the ledger may be sequenced and cryptographically linked. The blockchain object may be of two types, one with code capable of being executed on a node of a peer-to-peer network mining the blockchain, and one without code. Furthermore, the ledger is proliferated through many nodes in a network. Nodes perform logical functions and may be contained within one physical server or be distributed in many servers. The logical function is the execution of the smart contracts any may simulate the outcome of the transaction.

The Hyper Ledger Fabric is one example of a permissioned blockchain infrastructure for providing a modular architecture with a delineation of roles between the nodes in the infrastructure, execution of Smart Contracts (also called “chaincode”), and configurable consensus and membership services. The roles provide different types of interactions with the network, including: client nodes, peer nodes, and ordering nodes. Peer nodes may sometimes have the function of an endorser or an anchor.

Client nodes allow users to initiate transaction by submitting a transaction invocation request. The transaction invocation request is delivered to an endorser (e.g., peer node) and may contain metadata associated with the transaction as well as access credentials. Users access client nodes through a user-facing client application. In a use case involving the Hyperledger Fabric Network, the client application may use the Hyperledger Fabric SDK or REST web service to interact with the Hyper ledger Fabric network

Peer nodes function to receive requests and maintain the state of the network. This is accomplished via the endorser, orderer, or anchor functions. Individual nodes may be assigned one role or multiple roles. When acting out an endorser function, the peer node receives a transaction invocation request, validates the transaction, generates a response, and transmits an endorsement or otherwise rejection back to the client node. The orderer function receives an approved transaction from a client node and properly orders the transaction into a generated block. Additionally, the orderer broadcasts the generated block to all peer nodes on a relevant channel. This is also referred to as the ordering service. Peers receiving a new ordered block then ensure each transaction was signed by the appropriate endorsing peer and updates their local ledger with the latest block. Accordingly, the blockchain ledger is synced.

Some distributed ledgers group peers into organizations/associations for various reasons including control functionality or segmented trust domains. Peer nodes function as anchor nodes to bridge different organizations. For example, a peer node may broadcast, as an anchorer, to another anchor associated with a different organization.

Blockchain networks also commonly comprise nodes with different “stakes” in the network. Staking allows nodes to participate as validators in the network and may have a proportional relation to the resources contributed to the network. In some embodiments, these nodes may be known as committing peers.

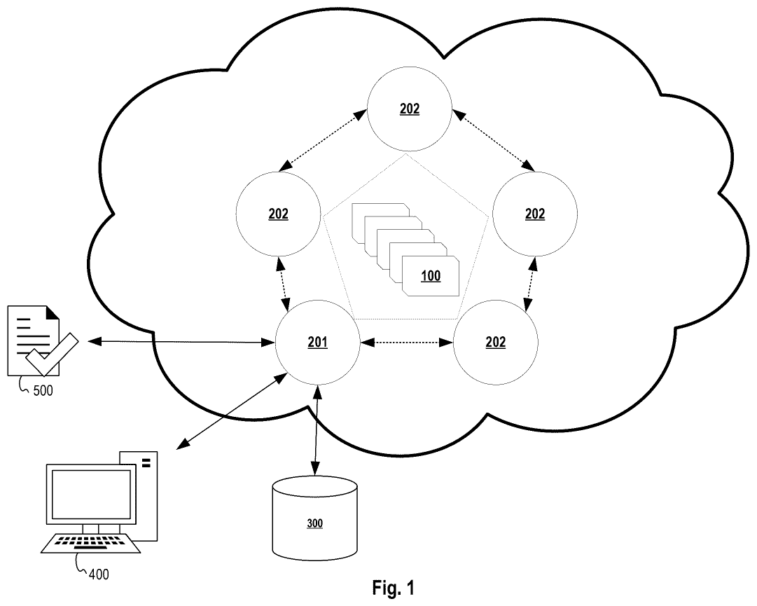

FIG. 1 shows a blockchain ledger system for shared digital confidential information comprising a blockchain ledger 100, a client node 201, a plurality of peer nodes 202, a computing device 300, a database 400, and access credentials 500. The blockchain ledger system may be implemented within a public or private network comprising confidential information requiring unique access credentials and it is desired to track its proliferation. The access to individual data may be permitted or restricted to some users, but the metadata associated with each search or request for access, successful or non-successful, is available on the blockchain ledger. In essence the blockchain is a “public” distributed ledger to track the proliferation of confidential data.

For example, a user may search for a confidential document (hereinafter “Doc A”), which may trigger a transaction invocation request in one embodiment. Additionally, a user may also trigger a transaction invocation request by opening Doc A, or requesting access to Doc A, but being denied permission. The transaction invocation requests log these events in real-time so that blockchain ledger remains current. New blocks contain information about who uploaded, sought out, or accessed particular confidential information. In this way, public transaction ledgers enable group-based information search and knowledge discovery via social user interfaces, which enable interactive nodal analysis.

In one embodiment, the confidential and be “classified” information, wherein the information has a security classification designated by a government or organization.

A blockchain ledger 100 is represented in FIG. 1 as stacked blocks shared among a plurality of nodes in a network (the network represented as a cloud). The blockchain is a distributed ledger comprising a plurality of local ledgers maintained at least some of the nodes, who constantly remain synced through deterministic consensus protocols. Because the ledger's design relies on deterministic consensus algorithms, any block validated by the orderer peer is guaranteed to be final and correct. Ledgers cannot fork the way they do in many other distributed and permissionless blockchain networks. The blockchain ledger 100 utilizes hashing cryptography to sequence an immutable chain of transactions. Accordingly, a tamper-proof log of confidential data.

The distributed computer environment of FIG. 1 includes public, private and dedicated networks. For example, a public network may be a cloud. A private network may be a private enterprise network or a private cloud. Dedicated networks may one third part network or dedicated cloud.

A client node 201 originates transaction invocations requests upon events including searching for or accessing data. The user may access the client node 201 via a user interface such as Hyperledger Fabric SDK or REST web service. While the client 201 shown in FIG. 1 is differentiated as a client node 201 among the other nodes, any node may share in the client functionality and is only presented as such for demonstration purposes.

The transaction invocation request is associated with information having a digital signature, cryptography, and a security designation that specifies qualifying access credentials. Comprised in the transaction invocation request is metadata and access credentials of the user. While the ledger logs transaction requests, permission and access functionality may be determined by a parallel application or module. However, the ledger may receive an approval or rejection associated with whether the security credential requirements for accessing the record. For example, a record may include a document, video, audio, or dataset. Metadata of the transaction invocation request may include the data being accessed, the user requesting access, the security profile of the data, and a timestamp.

One or more of plurality of peer nodes 202 may serve an endorser role in the network, configured to receive a transaction invocation request, endorse the transaction, and return the endorsed transaction action to the client node 201. To endorse a transaction a computing device may process instructions to the transaction validate the transaction based on the access credentials, wherein the access credentials of a user are compared to those required to access the information. The access credentials 500 are associated with a user's permission to view information and may be stored on a private or public server. Next, the transaction is simulated at the peer node. Then, an endorsed proposal response comprising a read-write set. Finally, an endorsed proposal response comprising an approval or a reject may be transmitted to the client node.

One or more of the plurality of peer nodes 202 may serve a role as an orderer in the network to receive the transaction back from the client node 201. At the orderer node, the ordered by the ordering service, maintain a tamper-proof order, and deploy a blockchain object to the blockchain ledger 100. Once a blockchain object is deployed, it must be shared with the network. Accordingly, the orderer may broadcast the transaction to the plurality of peers 202, and, at those peer nodes, update the plurality of local ledgers with the transaction block including the metadata to the public access history.

A database 300 contains a plurality of confidential data, each unit of data associated with a unique signature and cryptography, as discussed above. The database 300 may comprise stored information within the network or have off-network optionality. Furthermore, the database may comprise confidential information through one or more organizations. Organizations may be distinguished based on their association or access credentials, as two examples.

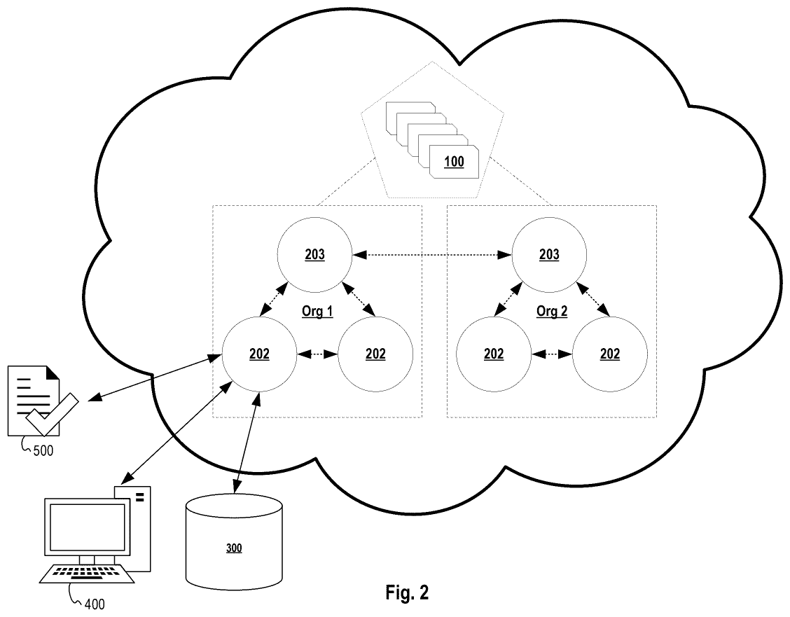

FIG. 2 shows a blockchain ledger system for shared digital confidential information further comprising a plurality of organizations. As shown in FIG. 2, an anchor node 203 may serve as a connection node between two or more organizations, enabling interoperability.

A computing device 400 typically includes a variety of non-transitory computer readable media capable of storing machine-readable instructions. Here, the computing device 400 may allow a user to access the client node. As an example, and not limitation, computer readable media may comprise Random Access Memory (RAM); Read Only Memory (ROM); Electronically Erasable Programmable Read Only Memory (EEPROM); flash memory or other memory technologies; CDROM, digital versatile disks (DVDs) or other optical or holographic media; magnetic cassettes, magnetic tape, magnetic disk storage or other magnetic storage devices, or any other medium that can be used to encode desired information and be accessed by computing device. Any such computer storage media may be part of computing device.

Memory includes computer storage media in the form of volatile and/or nonvolatile memory. The memory may be removable, non-removable, or a combination thereof. Examples of hardware devices include solid-state memory, hard drives, optical-disc drives, etc. Processors read data from various entities such as memory or I/O components. Memory stores, among other data, one or more applications. The applications, when executed by the one or more processors, operate to perform functionality on the computing device. The applications may communicate with counterpart applications or services such as web services accessible via a network (not shown). For example, the applications may represent downloaded client-side applications that correspond to server-side services executing in a cloud. In some examples, aspects of the disclosure may distribute an application across a computing system, with server-side services executing in a cloud based on input and/or interaction received at client-side instances of the application. In other examples, application instances may be configured to communicate with data sources and other computing resources in a cloud during runtime, such as communicating with a cluster manager or health manager during a monitored upgrade or may share and/or aggregate data between client-side services and cloud services.

A computer device 400 may further comprise a user interface, event service, and display component(s). The display component(s) present data indications to a participant or other device. Examples of presentation components include a display device, speaker, printing component, vibrating component, etc. I/O ports allow computing device to be logically coupled to other devices including I/O components 166, some of which may be include a microphone, joystick, game pad, satellite dish, scanner, printer, wireless device, etc.

The user interface allows a participant, such as a user or a system, to interact with the record and/or its associated blockchain object. For example, the system may generate different graphical user interfaces (GUIs) based on the current state of the record, the previous states of the record, future states, possible actions in the current state, possible actions based on the persona of the participant in the interaction, parameters of actions, and the like.

The event service (i.e., EventHub) receives events, such as the deployment of a blockchain object. In an example, the system may store context schema values in a data repository (e.g., a database) in off-chain storage to store the contextual information. The system may receive the interactions of the participants with the web browser application at the event stack in the form of events.

The event service may allow the system to process events in real-time. The event stack may queue events as the events arrive. The system may treat inputs received from outside the system as events and use the event stack to allow one or more services to process the events.

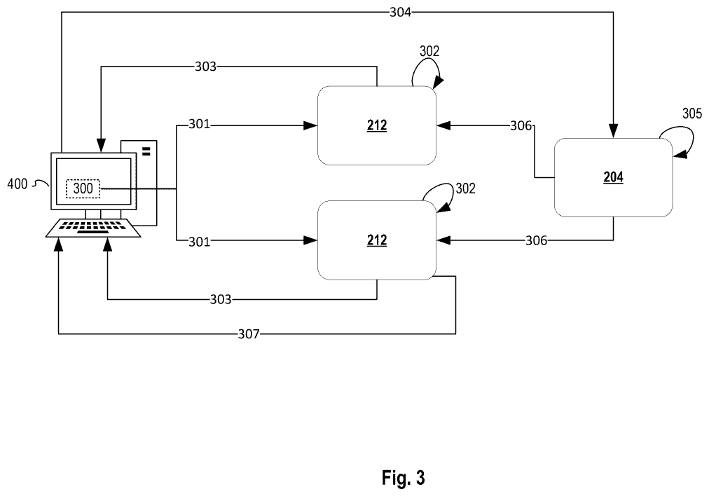

FIG. 3 shows a block diagram illustration of a method for tracking the proliferation of confidential data, comprising: initializing a transaction at a client node of the blockchain ledger, the transaction comprising access metadata and access credentials, broadcasting a transaction invocation request to a plurality of peer nodes 301, endorsing the transaction at one or more peer nodes 302, submitting the transaction to an order node 303, deploying a block comprising the transaction on a blockchain, wherein the transaction is properly ordered at the order node 305, broadcasting the transaction to the plurality of peers 306, and updating the plurality of local ledgers with the transaction block including the metadata to the public access history 307.

From the above description of a System and Method for Constructing Blockchain Ledger of Shared Digital Confidential Information, it is manifest that various techniques may be used for implementing the concepts of a blockchain ledger system and method for shared digital confidential information without departing from the scope of the claims. The described embodiments are to be considered in all respects as illustrative and not restrictive. The method/apparatus disclosed herein may be practiced in the absence of any element that is not specifically claimed and/or disclosed herein. It should also be understood that a blockchain ledger system and method for shared digital confidential information are not limited to the particular embodiments described herein, but is capable of many embodiments without departing from the scope of the claims.

What is claimed:

1. A blockchain ledger system for shared digital confidential information, comprising:
a blockchain ledger comprising a public access history of digital confidential information at a plurality of local ledgers;
a database comprising the digital confidential information accessible by users having access credentials;
a processor; and
a non-transitory computer readable medium storing machine-readable instructions that when executed by the processor cause the processor to:
initialize a transaction at a client node of the blockchain ledger, the transaction comprising access metadata and access credentials,
broadcast a transaction invocation request to a plurality of peer nodes,
endorse the transaction at one or more peer nodes,
submit the transaction to an order node,
deploy a block comprising the transaction on a blockchain, wherein the transaction is properly ordered at the order node,
broadcast the transaction to the plurality of peers, and
update the plurality of local ledgers with the transaction block including the metadata to the public access history.

2. The blockchain ledger system for shared digital confidential information of claim 1, further comprising:
an event service capable of presenting the public access history in real time.

3. The blockchain ledger system for shared digital confidential information of claim 1, wherein to endorse the machine-readable instructions are executed by the processor to:
validate the transaction based on the access credentials,
simulate the transaction,
generate an endorsed proposal response comprising a read-write set, and
transmit the endorsed proposal response comprising an approved.

4. The blockchain ledger system for shared digital confidential information of claim 1, wherein the machine-readable instructions are executed by the processor to:
broadcast the new transaction block to a plurality of anchor nodes, wherein the plurality of anchor nodes are associated with a plurality of member organizations.

5. The blockchain ledger system for shared digital confidential information of claim 1, wherein the machine-readable instructions are executed by the processor to:
deliver subscribed events to the client node.

6. A method for tracking the proliferation of confidential data, the steps comprising:
initializing a transaction at a client node of the blockchain ledger, the transaction comprising access metadata and access credentials,
broadcasting a transaction invocation request to a plurality of peer nodes,
endorsing the transaction at one or more peer nodes,
submitting the transaction to an order node,
deploying a block comprising the transaction on a blockchain, wherein the transaction is properly ordered at the order node,
broadcasting the transaction to the plurality of peers, and
updating the plurality of local ledgers with the transaction block including the metadata to the public access history.

7. The method for tracking the proliferation of confidential data of claim 6, further comprising the step of:
validating the transaction based on the access credentials,
simulating the transaction,
generating an endorsed proposal response comprising a read-write set, and
transmitting the endorsed proposal response comprising an approved.

8. The method for tracking the proliferation of confidential data of claim 6, further comprising the step of:
broadcasting the new transaction block to a plurality of anchor nodes, wherein the plurality of anchor nodes are associated with a plurality of member organizations.

9. The method for tracking the proliferation of confidential data of claim 6, further comprising the step of:
delivering subscribed events to the client node.
